(19) United States
(12) Patent Application Publication
(10) Pub. No.: US 2024/0396684 A1
(43) Pub. Date: Nov. 28, 2024

(54) MU-MIMO BASED ON SDM FOR PUSCH

(71) Applicant: QUALCOMM Incorporated, San Diego, CA (US)

(72) Inventors: Mostafa KHOSHNEVISAN, San Diego, CA (US); Wooseok NAM, San Diego, CA (US); Fang YUAN, Beijing (CN); Tao LUO, San Diego, CA (US)

(21) Appl. No.: 18/695,806

(22) PCT Filed: Dec. 3, 2021
(86) PCT No.: PCT/CN2021/135330

§ 371 Date: Mar. 26, 2024

(51) Int. Cl. H04L 5/00; H04B 7/0452; H04W 72/044

(52) U.S. Cl. CPC H04L 5/0048; H04B 7/0452; H04W 72/0466

(57) ABSTRACT

This disclosure provides systems, devices, apparatus, and methods, including computer programs encoded on storage media, for MU-MIMO communication based on SDM for a PUSCH. A UE may receive an indication of a plurality of DMRS ports for a PUSCH transmission and a number of DMRS CDM groups without data. The number of DMRS CDM groups without data is: greater than or equal to 3 when the plurality of DMRS ports is {0, 2}, greater than or equal to 2 when the plurality of DMRS ports is {1, 3}, or greater than or equal to 2 when the plurality of DMRS ports is {0, 2} and a number of front-loaded symbols corresponding to the plurality of DMRS ports is 2. The UE may transmit the PUSCH transmission based on the received indication of the plurality of DMRS ports and the number of DMRS CDM groups without data.

### TECHNICAL FIELD

The present disclosure relates generally to communication systems, and more particularly, to multi-user multiple-input multiple-output (MU-MIMO) communication based on spatial division multiplexing (SDM) for a physical uplink shared channel (PUSCH).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may receive an indication of a plurality of demodulation reference signal (DMRS) ports for a physical uplink shared channel (PUSCH) transmission and a number of DMRS code division multiplexing (CDM) groups without data, wherein the number of DMRS CDM groups without data is: greater than or equal to 3 when the plurality of DMRS ports is {0, 2}, greater than or equal to 2 when the plurality of DMRS ports is {1, 3}, or greater than or equal to 2 when the plurality of DMRS ports is {0, 2} and a number of front-loaded symbols corresponding to the plurality of DMRS ports is 2; and transmit the PUSCH transmission based on the received indication of the plurality of DMRS ports and the number of DMRS CDM groups without data.

In another aspect of the disclosure, a method, a computer-readable medium, and an apparatus are provided. The apparatus may transmit an indication of a plurality of DMRS ports for a PUSCH transmission and a number of DMRS CDM groups without data, wherein the number of DMRS CDM groups without data is: greater than or equal to 3 when the plurality of DMRS ports is {0, 2}, greater than or equal to 2 when the plurality of DMRS ports is {1, 3}, or greater than or equal to 2 when the plurality of DMRS ports is {0, 2} and a number of front-loaded symbols corresponding to the plurality of DMRS ports is 2; and receive the PUSCH transmission based on the transmitted indication of the plurality of DMRS ports and the number of DMRS CDM groups without data.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a call flow diagram illustrating communications between a base station and a plurality of UEs.

FIGS. 5A-5B illustrate diagrams of demodulation reference signal (DMRS) port configurations.

FIG. 6 illustrates antenna ports tables associated with DMRS configuration Type 1.

FIG. 7 illustrates antenna ports tables associated with DMRS configuration Type 2.

FIG. 8 illustrates a diagram associated with spatial division multiplexing (SDM) for a physical uplink shared channel (PUSCH).

FIG. 9 illustrates rank tables including DMRS port entries associated with SDM.

FIG. 10 is a flowchart of a method of wireless communication at a UE.

FIG. 11 is a flowchart of a method of wireless communication at a UE.

FIG. 12 is a flowchart of a method of wireless communication at a base station.

FIG. 13 is a flowchart of a method of wireless communication at a base station.

FIG. 14 is a diagram illustrating an example of a hardware implementation for an example apparatus.

FIG. 15 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

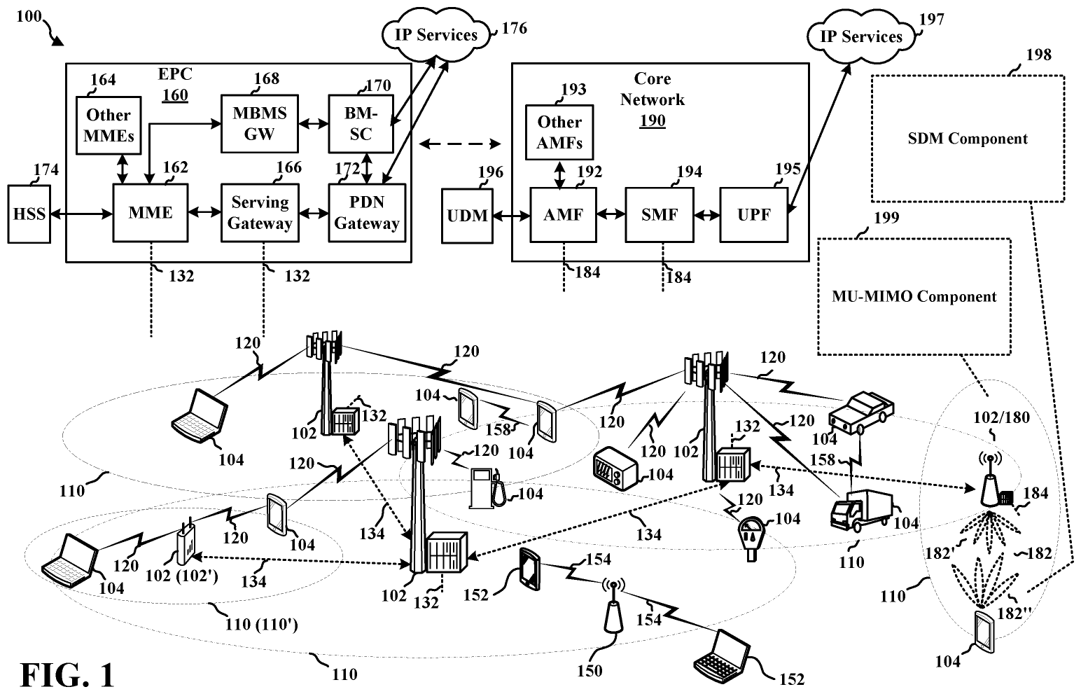

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as a gNB may operate in a traditional sub 6 GHZ spectrum, in millimeter wave frequencies, and/or near millimeter wave frequencies in communication with the UE 104. When the gNB operates in millimeter wave or near millimeter wave frequencies, the gNB may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information. The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services. The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a spatial division multiplexing (SDM) component 198 configured to receive an indication of a plurality of demodulation reference signal (DMRS) ports for a physical uplink shared channel (PUSCH) transmission and a number of DMRS code division multiplexing (CDM) groups without data, wherein the number of DMRS CDM groups without data is: greater than or equal to 3 when the plurality of DMRS ports is {0, 2}, greater than or equal to 2 when the plurality of DMRS ports is {1, 3}, or greater than or equal to 2 when the plurality of DMRS ports is {0, 2} and a number of front-loaded symbols corresponding to the plurality of DMRS ports is 2; and transmit the PUSCH transmission based on the received indication of the plurality of DMRS ports and the number of DMRS CDM groups without data. In certain aspects, the base station 180 may include a multi-user multiple-input multiple-output (MU-MIMO) component 199 configured to transmit an indication of a plurality of DMRS ports for a PUSCH transmission and a number of DMRS CDM groups without data, wherein the number of DMRS CDM groups without data is: greater than or equal to 3 when the plurality of DMRS ports is {0, 2}, greater than or equal to 2 when the plurality of DMRS ports is {1, 3}, or greater than or equal to 2 when the plurality of DMRS ports is {0, 2} and a number of front-loaded symbols corresponding to the plurality of DMRS ports is 2; and receive the PUSCH transmission based on the transmitted indication of the plurality of DMRS ports and the number of DMRS CDM groups without data. Although the following description may be focused on 5G NR, the concepts described herein may be applicable to other similar areas, such as LTE, LTE-A, CDMA, GSM, and other wireless technologies.

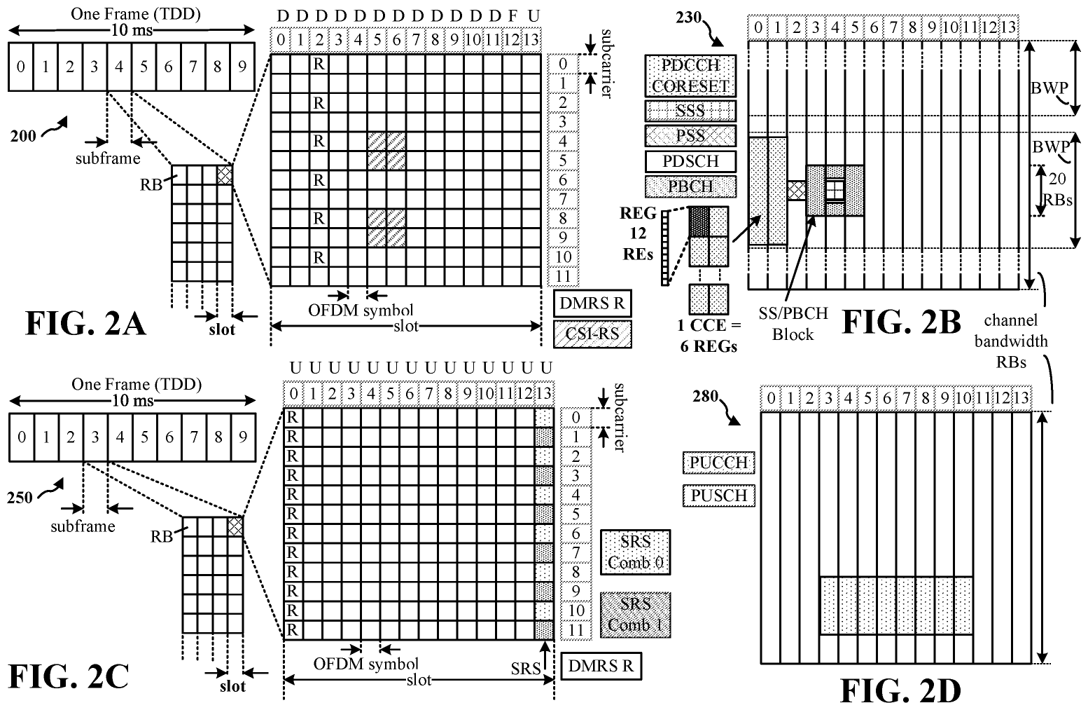

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

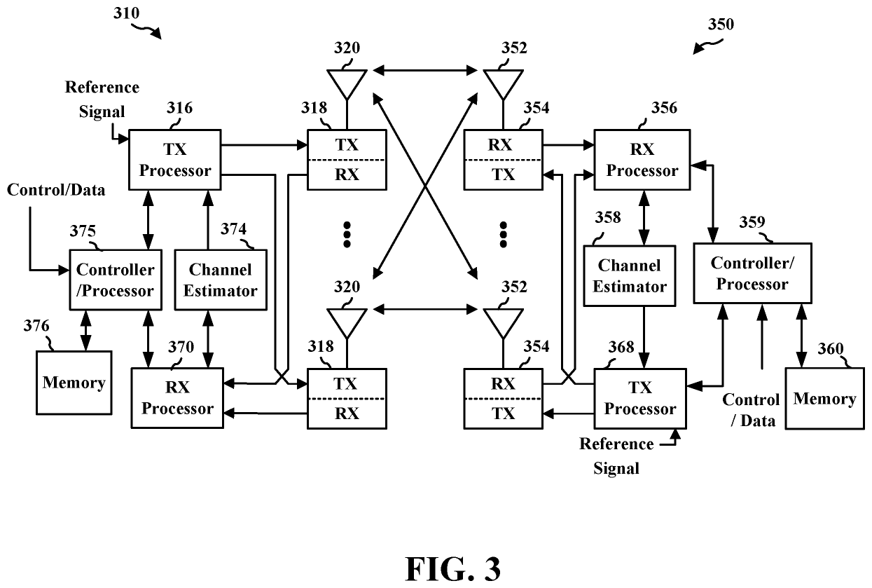

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality. The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the SDM component 198 of FIG. 1.

At least one of the TX processor 316, the RX processor 370, and the controller/processor 375 may be configured to perform aspects in connection with the MU-MIMO component 199 of FIG. 1.

Wireless communication systems may be configured to share available system resources and provide various telecommunication services (e.g., telephony, video, data, messaging, broadcasts, etc.) based on multiple-access technologies such as CDMA systems, TDMA systems, FDMA systems, OFDMA systems, SC-FDMA systems, TD-SCDMA systems, etc. that support communication with multiple users. In many cases, common protocols that facilitate communications with wireless devices are adopted in various telecommunication standards. For example, communication methods associated with eMBB, mMTC, and ultra-reliable low latency communication (URLLC) may be incorporated in the 5G NR telecommunication standard, while other aspects may be incorporated in the 4G LTE standard. As mobile broadband technologies are part of a continuous evolution, further improvements in mobile broadband remain useful to continue the progression of such technologies.

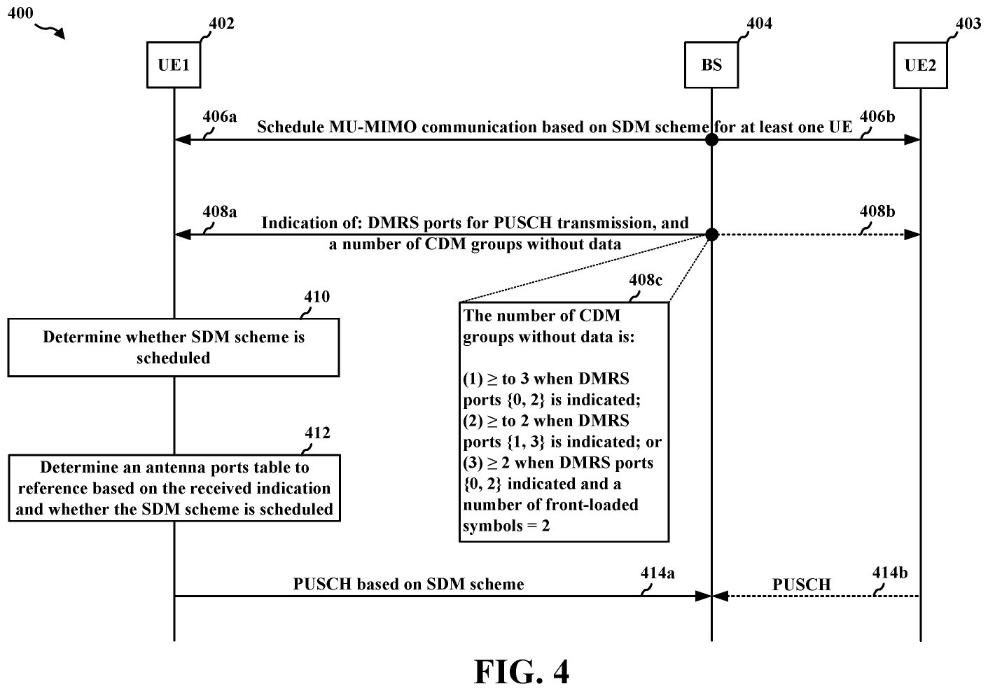

FIG. 4 is a call flow diagram 400 illustrating communications between a base station 404 and a plurality of UEs (e.g., a first UE 402 and a second UE 403). At 406a-406b, the base station 404 may schedule an MU-MIMO communication based on an SDM scheme for at least one UE. For example, the base station 404 may schedule, at 406a, the first UE 402 based on the SDM scheme and/or schedule, at 406b, the second UE 403 based on the SDM scheme or a non-SDM scheme. The SDM scheme may be associated with a PUSCH that includes different sets of layers having different transmission parameters (e.g., different beams, different sets of power control parameters, different precoding, etc.).

At 408a-408b, the base station 404 may transmit, to the first UE 402 and/or the second UE 403, an indication of DMRS ports for PUSCH transmission and a number of CDM groups without data. The indication of the DMRS ports for the PUSCH transmission and the number of CDM groups without data may be associated with the SDM scheme. The number of CDM groups without data may include the CDM groups of the indicated DMRS ports as well as additional CDM group(s). For example, in MU-MIMO communications, if another UE (e.g., the second UE 403) is scheduled with DMRS ports in the additional CDM group(s), the number of CDM groups without data may also be indicative of the additional CDM group(s) that are not available for data REs. Configurations indicated, at 408c, for the number of CDM groups without data may include that the number of CDM groups without data is: (1)≥ to 3 when DMRS ports {0, 2} is indicated; (2)> to 2 when DMRS ports {1, 3} is indicated; or (3)>2 when DMRS ports {0, 2} indicated and a number of front-loaded symbols=2.

At 410, the first UE 402 may determine whether the SDM scheme is scheduled by the base station 404 based on the indication received, at 406a, from the base station 404 of the DMRS ports for the PUSCH transmission and the number of CDM groups without data. For example, the configurations indicated, at 408c, may indicate that the SDM scheme is scheduled for the first UE 402. At 412, the first UE 402 may determine an antenna ports table to reference based on the received indication, at 408a, and whether the SDM scheme is determined, at 410, to be scheduled. Based on the determined antenna ports table to reference, at 412, the first UE 402 may transmit, at 414a, a PUSCH to the base station 404 based on the SDM scheme (e.g., if the SDM scheme is determined, at 412, to be scheduled). The base station 404 may also receive, at 414b, a PUSCH from the second UE 403, which may or may not be based on the SDM scheme.

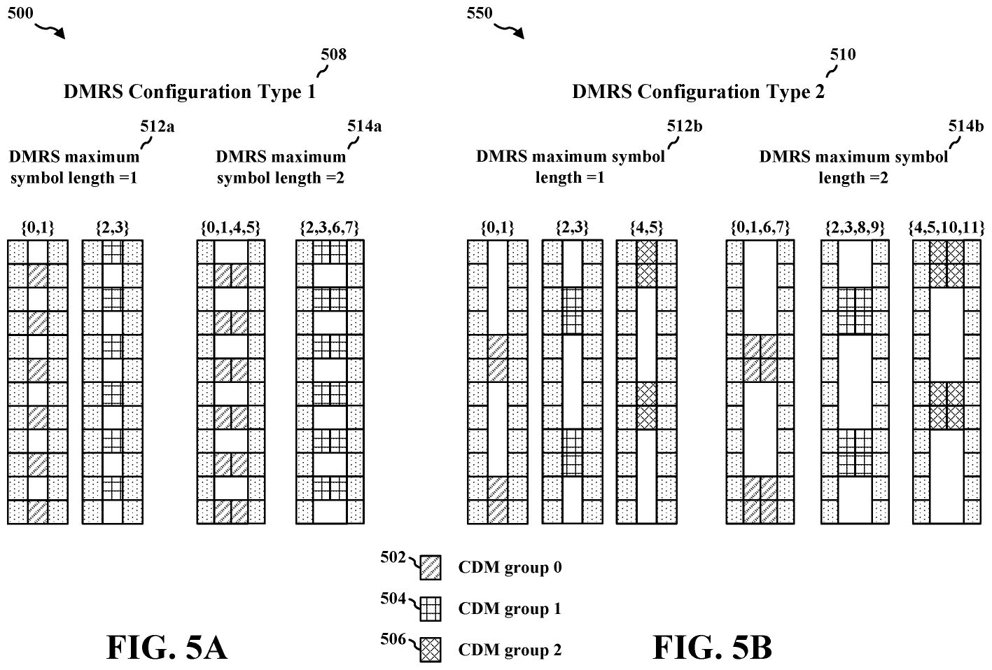

FIGS. 5A-5B illustrate diagrams 500-550 of DMRS port configurations. Different DMRS ports may be included within a same CDM group or different CDM groups. For example, DMRS ports {0,1} may be included within the same CDM group (e.g., CDM group 0 502), whereas DMRS ports {0,2} may be included in different CDM groups. For example, DMRS port 0 may be included in CDM group 0 502 and DMRS port 2 may be included in CDM group 1 504.

The DMRS port configurations may include DMRS configuration Type 1 508 and DMRS configuration Type 2 510. DMRS configuration Type 1 508 may be associated with 2 CDM groups (e.g., CDM group 0 502 and CDM group 1 504), whereas DMRS configuration Type 2 510 may be associated with 3 CDM groups (e.g., CDM group 0 502, CDM group 1 504, and CDM group 2 506). DMRS configuration Type 1 508 may include up to 8 DMRS ports (e.g., DMRS ports 0-7) and may be associated with a comb of 2 and a cyclic shift of 2. The comb 2 may correspond to 2 CDM groups (e.g., CDM group 0 502 and CDM group 1 504) for DMRS configuration Type 1 508, whereas the cyclic shift of 2 may be within a particular CDM group.

The DMRS port configurations may also be based on a DMRS maximum symbol length of 1 512a-512b or a DMRS maximum symbol length of 2 514a-514b. For a DMRS maximum symbol length of 1 OFDM symbol (e.g., at 512a), the comb 2 and the cyclic shift of 2 may be associated with up to 4 DMRS ports (e.g., DMRS ports 0-3) for DMRS configuration Type 1 508. The 2 CDM groups of DMRS configuration Type 1 508 may include CDM group 0 502 and CDM group 1. CDM group 0 502 may correspond to DMRS ports {0,1} based on the DMRS maximum symbol length of 1 512a. CDM group 1 504 may correspond to DMRS ports {2,3} based on the DMRS maximum symbol length of 1 512a.

For a maximum symbol length of 2 OFDM symbols (e.g., at 514a), the comb 2 and the cyclic shift of 2 may also be associated with a time division-orthogonal cover code (TD-OCC) and may support up to 8 DMRS ports (e.g., DMRS ports 0-7) for DMRS configuration Type 1 508. The 2 CDM groups of DMRS configuration Type 1 508 may include CDM group 0 502 and CDM group 1. CDM group 0 502 may correspond to DMRS ports {0,1,4,5} based on the DMRS maximum symbol length of 2 514a. CDM group 1 504 may correspond to DMRS ports {2,3,6,7} based on the DMRS maximum symbol length of 2 514a. The DMRS ports of the different CDM groups may be combed to provide orthogonality in the frequency domain.

DMRS configuration Type 2 510 may include up to 12 DMRS ports (e.g., DMRS ports 0-11) for a DMRS maximum symbol length of 2 514b and may be associated with a frequency domain-orthogonal cover code (FD-OCC) having adjacent REs in the frequency domain. For a DMRS maximum symbol length of 1 OFDM symbol (e.g., at 512b), 2 FD-OCCs may be utilized across adjacent REs in the frequency domain to support up to 6 DMRS ports (e.g., DMRS ports 0-5). DMRS configuration Type 2 510 may be associated with 3 CDM groups that include CDM group 0 502, CDM group 1 504, and CDM group 2 506. CDM group 0 502 may correspond to DMRS ports {0,1} based on the DMRS maximum symbol length of 1 512b, CDM group 1 504 may correspond to DMRS ports {2,3} based on the DMRS maximum symbol length of 1 512b, and CDM group 2 504 may correspond to DMRS ports {4,5} based on the DMRS maximum symbol length of 1 512b.

For a maximum symbol length of 2 OFDM symbols (e.g., at 514b), the 2 FD-OCCs utilized across the adjacent REs in the frequency domain may also be associated with a TD-OCC to support up to 12 DMRS ports (e.g., DMRS ports 0-11) for DMRS configuration Type 2 510. CDM group 0 502 may correspond to DMRS ports {0,1,6,7} based on the DMRS maximum symbol length of 2 514b, CDM group 1 504 may correspond to DMRS ports {2,3,8,9} based on the DMRS maximum symbol length of 2 514b, and CDM group 2 504 may correspond to DMRS ports {4,5, 10,11} based on the DMRS maximum symbol length of 2 514b. The DMRS ports of the different CDM groups may be combed to provide orthogonality in the frequency domain. In examples, DMRS ports 0-11 may also be referred to as DMRS ports 1000-1011.

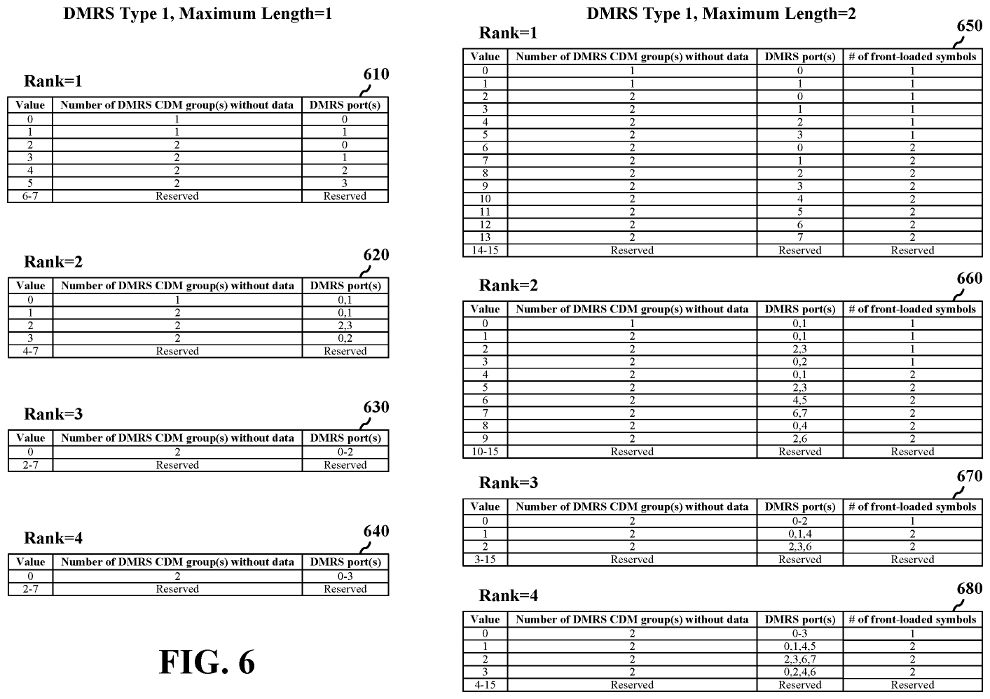

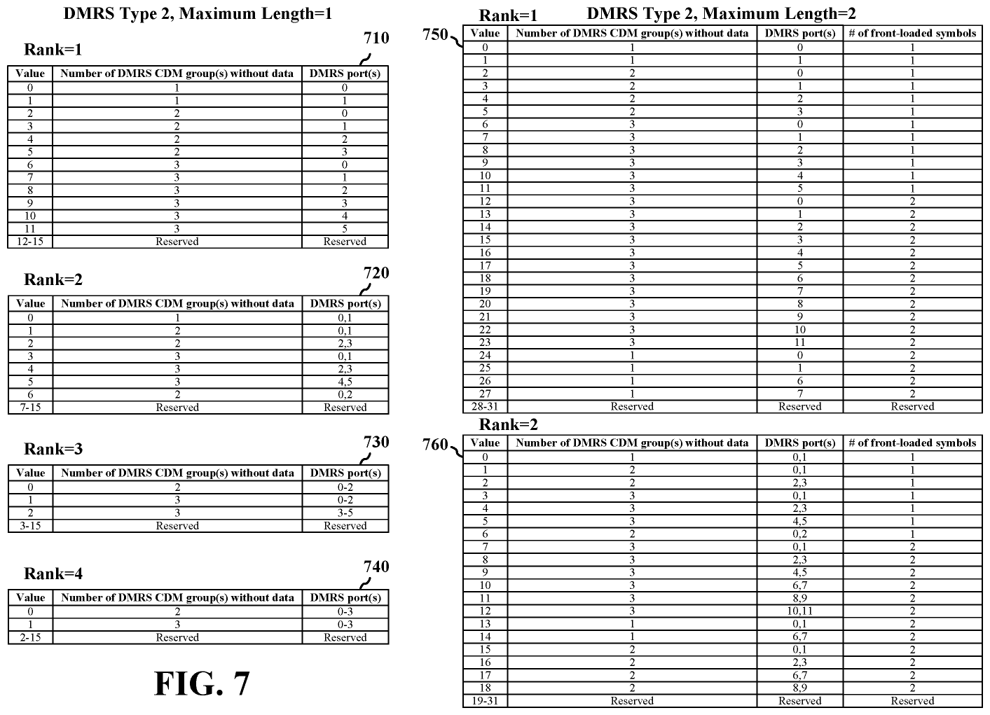

FIGS. 6-7 illustrate antenna ports tables 600-680 and 700-760 indicative of DMRS ports. More specifically, the antenna ports tables 600-680 correspond to DMRS configuration Type 1 and the antenna ports tables 700-760 correspond to DMRS configuration Type2. For DMRS configuration Type 1, the antenna ports tables 610-640 are based on a DMRS maximum symbol length of 1 and the antenna ports tables 650-680 are based on a DMRS maximum symbol length of 2. The antenna ports table 610 corresponds to rank 1, the antenna ports table 620 corresponds to rank 2, the antenna ports table 630 corresponds to rank 3, and the antenna ports table 640 corresponds to rank 4. Similarly, the antenna ports table 650 corresponds to rank 1, the antenna ports table 660 corresponds to rank 2, the antenna ports table 670 corresponds to rank 3, and the antenna ports table 680 corresponds to rank 4.

For DMRS configuration Type 2, the antenna ports tables 710-740 are based on a DMRS maximum symbol length of 1 and the antenna ports tables 750-760 are based on a DMRS maximum symbol length of 2. The antenna ports table 710 corresponds to rank 1, the antenna ports table 720 corresponds to rank 2, the antenna ports table 730 corresponds to rank 3, and the antenna ports table 740 corresponds to rank 4. Similarly, the antenna ports table 750 corresponds to rank 1 and the antenna ports table 760 corresponds to rank 2. DMRS configuration Type 2 with a DMRS maximum symbol length of 2 may also be associated with a rank 3 antenna ports table and a rank 4 antenna ports table (not illustrated). Thus, 16 antenna ports tables may be defined in total to cover both DMRS configuration Type 1 and DMRS configuration Type 2 with DMRS maximum symbol lengths of 1 and 2.

An antenna ports field of a scheduling DCI (e.g., a DCI that schedules a PUSCH) may be used to indicate DMRS ports for a PUSCH transmission. For example, the indication of the DMRS ports may correspond to an entry of the antenna ports tables 610-680 and 710-760, which may be RRC configured or indicted via DCI. A DMRS maximum symbol length (e.g., 1 symbol or 2 symbols) may also be RRC configured or indicated via DCI. In examples where the DMRS maximum symbol length is equal to 2, an actual DMRS symbol length may still be equal to 1.

Bits of the antenna ports field of the DCI may correspond to code points associated with the antenna ports tables 610-680 and 710-760. For instance, if the antenna ports field includes 3 bits, the antenna ports field may be indicative of 8 code points/table rows associated with the antenna ports tables 610-640. If the antenna ports field includes 4 bits, the antenna ports field may be indicative of 16 code points/table rows associated with the antenna ports tables 650-680 and 710-740. If the antenna ports field includes 5 bits, the antenna ports field may be indicative of 32 code points/table rows associated with the antenna ports tables 750-760 as well as the rank 3 and rank 4 tables for DMRS configuration Type 2 with a DMRS maximum symbol length of 2. A rank/number of layers associated with a transmission may be indicated by other DCI fields, by an SRS resource indicator (SRI) field in cases of non-codebook based uplink transmission, and/or by a transmitted precoding matrix indicator (TPMI) field in cases of codebook-based uplink transmissions.

An antenna ports table indicated by the antenna ports field of the DCI may include one or more reserved rows. For example, the antenna ports table 620 may include 8 rows, where rows 0-3 include antenna port information and rows 4-7 are reserved rows. The reserved rows may be incorporated in the antenna ports tables 610-680 and 710-760 to provide a fixed size for the DCI, in cases where the antenna ports table 610-680 and 710-760 are not RRC configured. The antenna ports tables 610-680 and 710-760 may indicate DMRS port numbers as well as a number of CDM groups without data. If REs are used for DMRS, the REs may not be used for data/PUSCH. Hence, the number of CDM groups without data may include the CDM groups of the indicated DMRS ports as well as other CDM groups. For example, in MU-MIMO communications, if other UEs are scheduled with DMRS ports in the other CDM groups, the number of CDM groups without data column may also be indicative of the other CDM groups that are not available for data REs.

The antenna ports table 650, for example, may include table rows for both DMRS port 0 and DMRS port 1 with a number of front-loaded symbols equal to 1. However, two options may be available for the number of CDM groups without data (e.g., 1 CDM group without data or 2 CDM groups without data). If there are 2 CDM groups without data and the DMRS port corresponds to DMRS port 0, the DMRS may be scheduled in a first CDM group (e.g., CDM group 0) and a second CDM group (e.g., CDM group 1) may also not be used for data, as the number of CDM groups without data corresponds to 2. DMRS configuration Type 2 may be associated with 3 CDM groups. Thus, the number of CDM groups without data may be 1, 2, or 3 CDM groups (e.g. CDM groups 0-2).

The antenna ports field of the DCI may be interpreted based on a corresponding row of an indicated antenna ports table. The number of CDM groups without data may include the CDM groups of the indicated/scheduled DMRS ports for the UE as well as additional CDM groups. For example, in MU-MIMO communication, the base station may schedule multiple UEs on the same resources (e.g., same PRBs), such that different DMRS ports may be indicated for different UEs. For a particular UE, if non-scheduled CDM groups are used for DMRS ports of one or more co-scheduled UEs, the non-scheduled CDM groups may be included in the number of CDM groups without data. The particular UE may not transmit data tones in REs that correspond to the CDM groups associated with the number of CDM groups without data. In addition to MU-MIMO scheduling across CDM groups, MU-MIMO scheduling may also be performed within a CDM group. For example, different ports of a same CDM group may be used for different co-scheduled UEs.

In an example associated with the antenna ports tables 610 and 630, MU-MIMO communication may be performed via the same RBs for a first UE with a rank equal to 1 (e.g., based on DMRS port 3) and a second UE with a rank equal to 3 (e.g., based on DMRS ports 0-2). The number of CDM groups without data may be equal to 2, so that another CDM group may remain available for the MU-MIMO communication. In another example associated with the antenna ports table 610, MU-MIMO communication may be performed within a same CDM group. For example, the first two rows of the antenna ports table 610 may be used for two different UEs, where the UEs may be scheduled on the same RBs. That is, both DMRS port 0 indicated in the first row of the antenna ports table 610 and DMRS port 1 indicated in the second row of the antenna ports table 610 may correspond to the same CDM group. In yet another example associated with the antenna ports table 620, MU-MIMO communication may be performed across different CDM groups. For instance, DMRS ports {0, 1} may be used for a first UE and DMRS ports {2,3} may be used for a second UE, where each set of DMRS ports corresponds to a different CDM group.

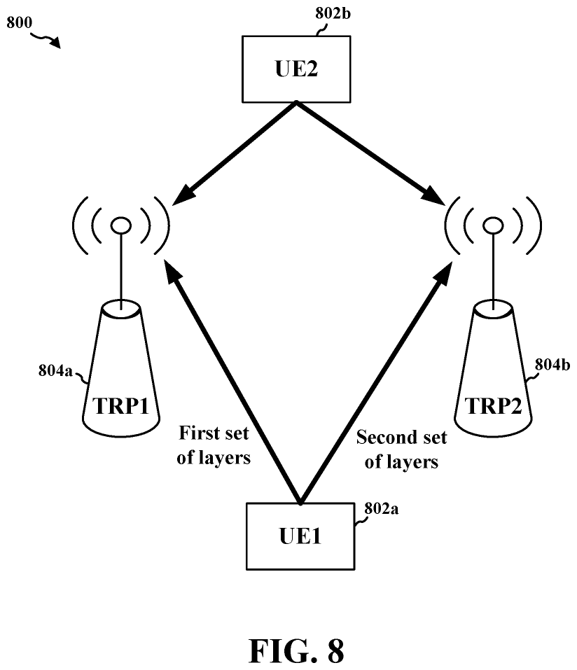

FIG. 8 illustrates a diagram 800 associated with SDM for a PUSCH. For example, a first UE 802a may transmit a PUSCH based on different sets of layers having different transmission parameters (e.g., different beams, different sets of power control parameters, different precoding, etc.). The different sets of layers may include a first set of layers directed toward a first TRP 804a and a second set of layers directed toward a second TRP 804b. Thus, in a given PUSCH, the different sets of layers may have different transmission parameters.

The first set of layers may be associated with a first SRS resource set and the second set of layers may be associated with a second SRS resource set. The SRS resource set may be used for indicating/enabling the different transmission parameters. Potential rank combinations for the PUSCH may include rank combinations 1+1, 1+2, 2+1, and 2+2. For instance, rank combination 1+1 may correspond to a PUSCH that includes 2 layers, where the first layer has a first set of transmission parameters and a second layer has a second set of transmission parameters. Similarly, rank combination 2+1 may correspond to a PUSCH that includes 3 layers, where the first 2 layers have the first set of transmission parameters and the third layer has the second set of transmission parameters.

DMRS ports that correspond to different CDM groups for the first set of layers and the second set of layers may provide improved channel estimations at a base station. For rank combination 1+1, DMRS ports {0,2} may be indicated, where DMRS port 0 may be included in the first CDM group (e.g., CDM group 0) and DMRS port 2 may be included in the second CDM group (e.g., CDM group 1). However, DMRS port 0 and DMRS port 1 may not both be indicated, given that DMRS port 0 and DMRS port 1 are included in the same CDM group (e.g., CDM group 0). For rank combination 2+1, DMRS ports {0, 1; 2} may be indicated, where DMRS port 0 and DMRS port 1 correspond to the first layer and may be included in the first CDM group (e.g., CDM group 0), and DMRS port 2 corresponds to the second layer and may be included in the second CDM group (e.g., CDM group 1).

Some antenna ports tables may not support SDM procedures of the first UE 802a and/or MU-MIMO communication across different UEs (e.g., the first UE 802a and a second UE 802b). However, one or more co-scheduled UEs, such as the second UE 802b, may be scheduled based on an SDM scheme. In the diagram 800, if the first UE 802a is scheduled based on the SDM scheme with rank combination 1+1 (e.g., the first UE 802a is scheduled with 2 layers/DMRS ports), the first UE 802a may be assigned DMRS ports {0,2}, such that the 2 layers/DMRS ports correspond to different CDM groups. DMRS port entry {1,3}, which may be absent from certain antenna ports tables, would have to be assigned to the second UE 802b, if the second UE 802b is also scheduled based on the SDM scheme with rank combination 1+1 in different CDM groups, or if the second UE 802b is scheduled with 2 layers for a same beam (e.g., directed toward a same TRP) with 1 symbol for DMRS.

For DMRS configuration Type 1, the only available DMRS ports that may be assigned to the second UE 802b may be DMRS ports {1,3}. That is, if there are a total of 4 DMRS ports, and DMRS ports {0,2} are assigned to the first UE 802a, DMRS ports {1,3} may be the only remaining available DMRS ports that can be assigned to the second UE 802b. Alternatively, the second UE 802b may be scheduled with one layer/DMRS port (e.g., DMRS port 1). If DMRS port entry {1,3} is unavailable to the second UE 802b, the second UE 802b may not be scheduled with rank 2. For DMRS configuration Type 2, a third CDM group may be used. However, DMRS port entry {0,2} having 3 CDM groups without data may be unavailable (e.g., absent from certain antenna ports tables) for the first UE 802a. Utilizing a third CDM group may generate additional overhead, as 2 CDM groups would otherwise be sufficient if DMRS port entry {1,3} was an available DMRS port entry to be indicated. In examples, the SDM scheme may be implemented based on the number of CDM groups without data being equal to 3 or more when the DMRS ports are associated with a first orthogonal cover code (OCC) of {1,1} and being equal to 2 or more when the DMRS ports are associated with a second OCC of {1,−1}.

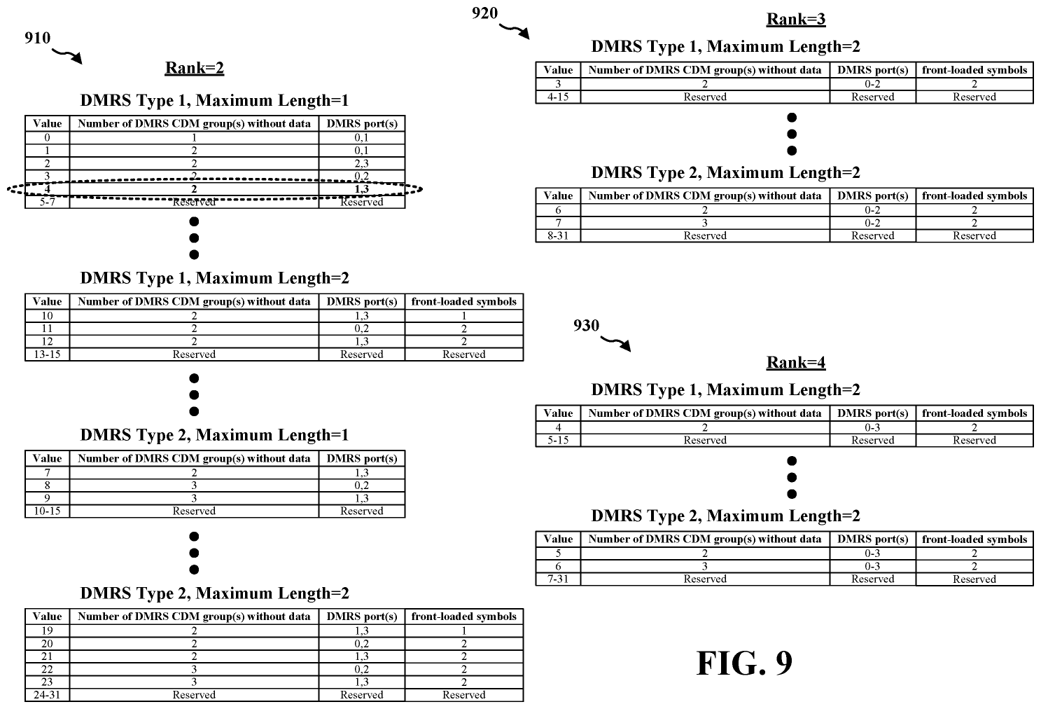

FIG. 9 illustrates rank tables 910-930 including DMRS port entries associated with SDM. The rank tables 910 are based on rank 2 and correspond to both DMRS configuration Type 1 and DMRS configuration Type 2 for DMRS maximum symbol lengths of 1 and 2. The rank tables 920 are based on rank 3 and correspond to both DMRS configuration Type 1 and DMRS configuration Type 2 for a DMRS maximum symbol length of 2. The rank tables 930 are based on rank 4 and correspond to both DMRS configuration Type 1 and DMRS configuration Type 2 for a DMRS maximum symbol length of 2.

One or more DMRS port entries for PUSCH scheduling at the UE (e.g., indicated via the rank tables 910-930) may be added to the antenna ports tables 620, 660-680, 720, 760, and associated rank 3 and rank 4 tables (not illustrated in FIG. 7) for DMRS configuration Type 2 with a DMRS maximum symbol length of 2. The one or more DMRS port entries may be added based on the reserved rows of the tables, so that no additional bits have to be added to the DCI. For example, the rank tables 910 indicate that DMRS port entry {1,3} may be added at a reserved row of the antenna ports tables 620, 660, 720, and 760 for rank 2, which corresponds to cases of DMRS configuration Type 1 and DMRS configuration Type 2, as well as DMRS maximum symbol lengths of 1 and 2. The number of CDM groups without data may be 2 for the added table row that includes DMRS port entry {1,3}. Thus, two different UEs may be scheduled based on the additions of rank tables 910, where a first UE may be scheduled based on DMRS ports {0,2} and a second UE may be scheduled based on DMRS ports {1,3}. Accordingly, the base station may schedule the 2 UEs with orthogonal DMRS ports (e.g., DMRS ports {0,2} and DMRS ports {1,3}) on the same PRBs. Both UEs may be scheduled based on the SDM scheme, or one of the UEs may be scheduled based on the SDM scheme and the other UE may communicate via 2 layers.

DMRS port entry {0,2} with a number of CDM groups without data being equal to 3 may also be added at a reserved row of the antenna ports table for rank 2, as indicated in the rank tables 910. The DMRS port entry may be used for DMRS configuration Type 2, as DMRS configuration Type 1 may not include 3 CDM groups. DMRS port entry {0,2} may also be used when the number of CDM groups without data is equal to 2. However, the added DMRS port entry based on 3 CDM groups without data may allow the base station to schedule the SDM scheme for the UE with DMRS ports {0,2} and also schedule other UE(s) with DMRS ports from the third CDM group on the same PRBs. For example, the first UE may be scheduled with DMRS ports {0,2} and the second UE may be scheduled with DMRS ports {4,5}, which may correspond to the third CDM group. In further examples, a third UE may be scheduled with another DMRS port (e.g., DMRS port 1 based on 1 layer) and a fourth UE may be scheduled with yet another DMRS port (e.g., DMRS port 3). The first UE may receive an indication that the number of CDM groups without data is equal to 3, so that the other DMRS ports are not used by the first UE for data. A third DMRS port entry for DMRS ports {1,3} with the number of CDM groups without data being equal to 3 may also be added to the antenna ports tables 720 and 760, as indicated in the rank tables 910.

DMRS port entry {0,2} with a number of front-loaded symbols equal to 2 may also be added to the antenna ports table 660 and 760 for rank 2, as indicated in the rank tables 910. Some antenna ports tables may include DMRS port entry {0,2} with a number of front-loaded symbols equal to 1, but may not be based on the SDM scheme. For DMRS port entry {0,2} with the number of front-loaded symbols equal to 2, the number of CDM groups without data may be equal to 2 or 3. Three CDM groups without data may correspond to DMRS configuration Type 2.

The base station may schedule the SDM scheme for the UE based on DMRS ports {0,2} with 2 front-loaded DMRS symbols and may also schedule one or more UEs with other orthogonal DMRS ports on the same PRBs. For a large number of co-scheduled UEs, 2 front-loaded symbols may be used to double a number of available DMRS ports, e.g., where one of the UEs may be scheduled based on the SDM scheme via DMRS ports {0,2}. In an example for DMRS configuration Type 1 based on 8 total DMRS ports, where a DMRS maximum symbol length is equal to 2 and a number of front-loaded DMRS symbols is equal to 2, a first UE may be scheduled with DMRS ports {0,2} based on the SDM scheme. Further to the example, a second UE may be scheduled with DMRS ports {4,5}, a third UE3 may be scheduled with DMRS port 5, and a fourth UE may be scheduled with DMRS port 6. Still further to the example, a fifth UE could be scheduled with DMRS port 1 and a sixth UE could be scheduled with DMRS port 3. DMRS port numbers of 4 or larger may be associated with the second front-loaded DMRS symbol. For instance, if DMRS ports {0,2} are scheduled with 2 front-loaded symbols, the second UE may be scheduled with DMRS port {4,5}, etc.

The DMRS port entry {1,3} with the number of front-loaded DMRS symbols equal to 2 may also be utilized for the SDM scheme. Similarly, as indicated in the rank tables 920, DMRS port entry {0,1,2} with rank 3 may be utilized for the SDM scheme, e.g., based on a rank combination of 2+1 layers. The DMRS port entry {0,1,2} may be scheduled based on the number of front-loaded symbols being equal to 2. That is, if the UE receives an indication of DMRS port entry {0,1,2} and is scheduled based on the SDM with the rank combination 2+1, the DMRS ports may be associated with 2 front-loaded DMRS symbols.

As indicated in the rank tables 930, DMRS port entry {0,1,2,3} with rank 4 may likewise be scheduled based on the SDM scheme with a rank combination of 2+2 layers. DMRS ports {0,1} may correspond to the first set of layers and DMRS ports {2,3} may correspond to the second set of layers for a particular UE. In addition to the particular UE being scheduled based on the SDM scheme, other UEs may be scheduled with a further number of ports, such that the DMRS port entry may be associated with the number of front-loaded symbols being equal to 2. For example, DMRS entry {0,1,2,3} may be scheduled based on 2 front-loaded DMRS symbols.

If the UE is configured/scheduled with the SDM scheme for a PUSCH based on two sets of layers associated with two SRS resource sets having different transmission parameters, such as different beams parameters, precoding parameters, power control parameters, etc., the antenna ports field indicated via the DCI may correspond to an SDM antenna ports table. That is, rather than adding DMRS port entries to reserved rows of the antenna ports table, as indicated in the rank tables 910-930, an SDM antenna ports table may be generated/configured based on DMRS port entries associated with the SDM scheme. The UE may determine whether to use the SDM antenna ports table or the non-SDM antenna ports table based on whether the UE is scheduled with the SDM scheme. If the UE is scheduled with the SDM scheme, the antenna ports field indicative via the DCI may be interpreted based on the SDM antenna ports table.

The SDM antenna ports table for a particular DMRS configuration Type, DMRS maximum symbol length, rank, etc., may include one or more non-SDM antenna port entries in addition to one or more SDM antenna port entries. Thus, rather than selecting between a non-SDM antenna ports table and an SDM antenna ports table, the SDM antenna port entries and the non-SDM antenna ports entries may be included in a single table from which the antenna ports field may indicate an entry via the DCI. The SDM scheme may be indicated based on the DCI or RRC signaling. The UE may determine a table to reference based on an RRC configuration and/or the indication in the DCI.

Some of the non-SDM antenna port entries may not be indicated in association with the SDM scheme. For example, non-SDM antenna port entries with one DMRS port or non-SDM antenna port entries with DMRS ports corresponding to one CDM group may not be used in association with the SDM scheme, which may be based on at least 2 layers. Removing antenna port entries associated with 1 DMRS port or one CDM group may reduce DCI overhead in cases where adding SDM antenna port entries to the tables increases a size of the antenna ports field.

For MU-MIMO communication, the base station may schedule a first UE with the SDM scheme based on indicating DMRS ports associated with the rank tables 910-930. The first UE may be scheduled on same PRBs used for one or more UEs scheduled based on either the SDM antenna port entries or the non-SDM antenna ports entries. The DMRS port entry indicated to the UE may be based on rank combinations, such as 1+1, 1+2, 2+1, or 2+2, for the SDM scheme. The DMRS port entry indicated to the UE may also be based on whether the communication is an MU-MIMO communication, a number of co-scheduled UEs, a rank of the co-scheduled UEs, DMRS configuration type, and/or a DMRS maximum symbol length.

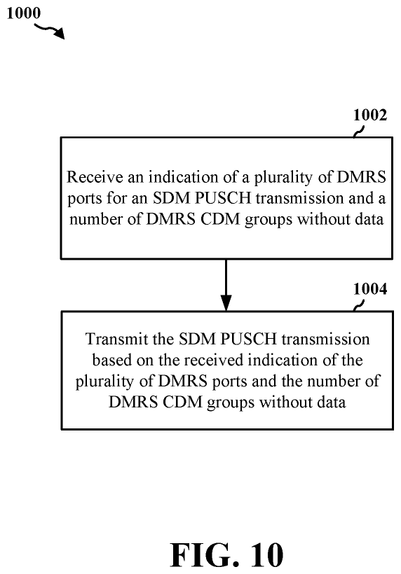

FIG. 10 is a flowchart 1000 of a method of wireless communication. The method may be performed by a first UE (e.g., the UE 104, 402, 802a-802b; the apparatus 1402; etc.), which may include the memory 360 and which may be the entire first UE 104, 402, 802a-802b or a component of the first UE 104, 402, 802a-802b, such as the TX processor 368, the RX processor 356, and/or the controller/processor 359.

At 1002, the first UE may receive an indication of a plurality of DMRS ports for an SDM PUSCH transmission and a number of DMRS CDM groups without data. For example, referring to FIG. 4, the first UE 402 may receive, at 408a, an indication from the base station 404 of DMRS ports for a PUSCH transmission and a number of CDM groups without data. The indicated number of CDM ports without data may be associated with an SDM scheme.

At 1004, the first UE may transmit the SDM PUSCH transmission based on the received indication of the plurality of DMRS ports and the number of DMRS CDM groups without data. For example, referring to FIGS. 4 and 9, the first UE 402 may transmit, at 414a, a PUSCH based on the SDM scheme associated with the indication received, at 408a, of the DMRS ports for the PUSCH transmission and the number of CDM groups without data. The SDM scheme may correspond to one or more entries of the rank tables 910-930.

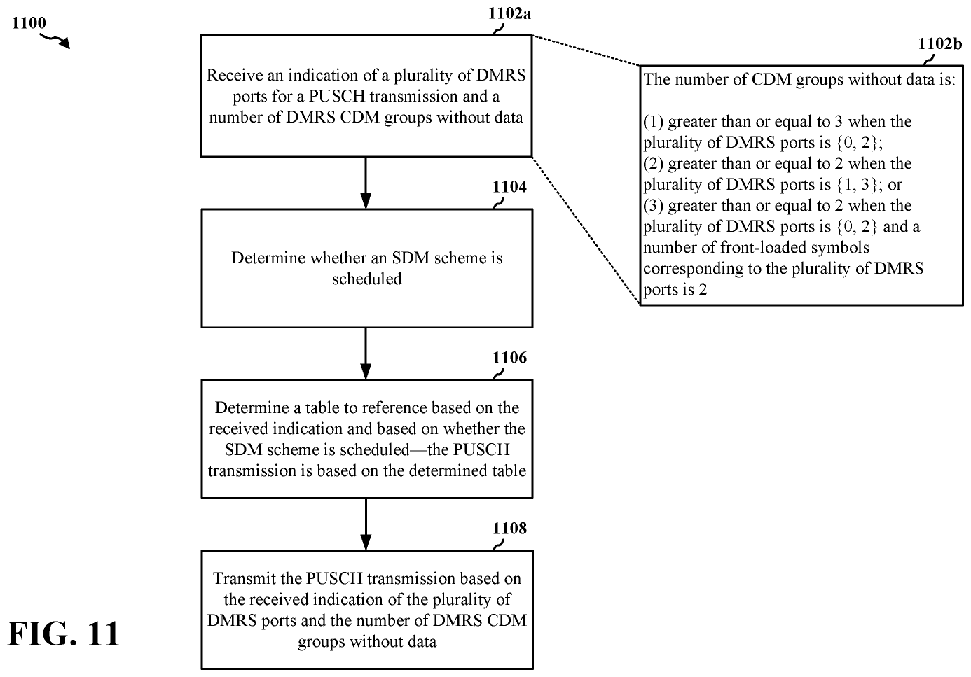

FIG. 11 is a flowchart 1100 of a method of wireless communication. The method may be performed by a first UE (e.g., the UE 104, 402, 802a-802b; the apparatus 1402; etc.), which may include the memory 360 and which may be the entire first UE 104, 402, 802a-802b or a component of the first UE 104, 402, 802a-802b, such as the TX processor 368, the RX processor 356, and/or the controller/processor 359.

At 1102a, the first UE may receive an indication of a plurality of DMRS ports for a PUSCH transmission and a number of DMRS CDM groups without data. For example, referring to FIG. 4, the first UE 402 may receive, at 408a, an indication from the base station 404 of DMRS ports for a PUSCH transmission and a number of CDM groups without data. The indicated number of CDM ports without data may be associated with an SDM scheme.

At 1102b, the number of CDM groups without data is: (1) greater than or equal to 3 when the plurality of DMRS ports is {0, 2}; (2) greater than or equal to 2 when the plurality of DMRS ports is {1, 3}; or (3) greater than or equal to 2 when the plurality of DMRS ports is {0, 2} and a number of front-loaded symbols corresponding to the plurality of DMRS ports is 2. For example, referring to FIGS. 4-9, the number of CDM groups without data indicated, at 408a, may correspond to configurations indicated, at 408c, where the number of CDM groups without data is: (1)≥ to 3 when DMRS ports {0, 2} is indicated; (2)≥ to 2 when DMRS ports {1, 3} is indicated; or (3)≥2 when DMRS ports {0, 2} indicated and a number of front-loaded symbols=2. The configurations indicated, at 408c, may correspond to one or more entries of the rank tables 910-930.

At 1104, the first UE may determine whether an SDM scheme is scheduled. For example, referring to FIGS. 4 and 9, the first UE 402 may determine, at 410, whether an SM scheme is scheduled (e.g., based on scheduling information received, at 406a, from the base station 404). The SDM scheme may correspond to one or more entries of the rank tables 910-930.

At 1106, the first UE may determine a table to reference based on the received indication and based on whether the SDM scheme is scheduled—the PUSCH transmission is based on the determined table. For example, referring to FIG. 4, the first UE 402 may determine, at 412, an antenna ports table to reference based on the received indication, at 408a, from the base station 404 and whether the SDM scheme is determined, at 412, to be scheduled by the base station 404. The UE first 402 may transmit a PUSCH, at 414a, to the base station 404 based on the antenna ports tabled determined, at 412.

At 1108, the first UE may transmit the PUSCH transmission based on the received indication of the plurality of DMRS ports and the number of DMRS CDM groups without data. For example, referring to FIGS. 4 and 9, the first UE 402 may transmit, at 414a, a PUSCH based on the SDM scheme associated with the received indication, at 408a, of the DMRS ports for the PUSCH transmission and the number of CDM groups without data. The SDM scheme may correspond to one or more entries of the rank tables 910-930.

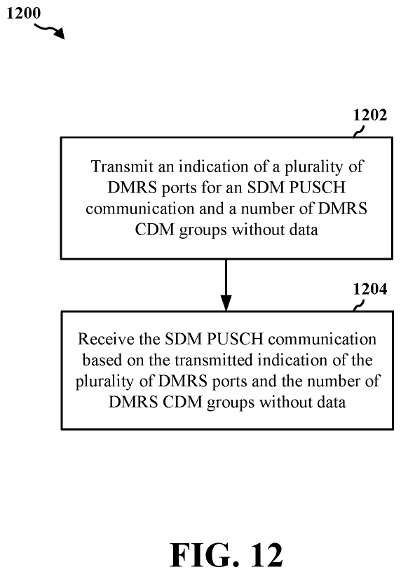

FIG. 12 is a flowchart 1200 of a method of wireless communication. The method may be performed by a base station (e.g., the base station 102, 404; TRP1 804a; TRP2 804b; the apparatus 1502; etc.), which may include the memory 376 and which may be the entire base station 102, 404 or a component of the base station 102, 404, such as the TX processor 316, the RX processor 370, and/or the controller/processor 375.

At 1202, the base station may transmit an indication of a plurality of DMRS ports for an SDM PUSCH communication and a number of DMRS CDM groups without data. For example, referring to FIG. 4, the base station 404 may transmit, at 408a-408b, an indication to the first UE 402 and/or the second UE 403 of the DMRS ports for the PUSCH transmission and the number of CDM groups without data. The indicated number of CDM ports without data may be associated with an SDM scheme.

At 1204, the base station may receive the SDM PUSCH communication based on the transmitted indication of the plurality of DMRS ports and the number of DMRS CDM groups without data. For example, referring to FIGS. 4 and 9, the base station 404 may receive, at 414a-414b, one or more PUSCHs based on the SDM scheme associated with the transmitted indication, at 408a-408b, of the DMRS ports for the PUSCH transmission and the number of CDM groups without data. The SDM scheme may correspond to one or more entries of the rank tables 910-930.

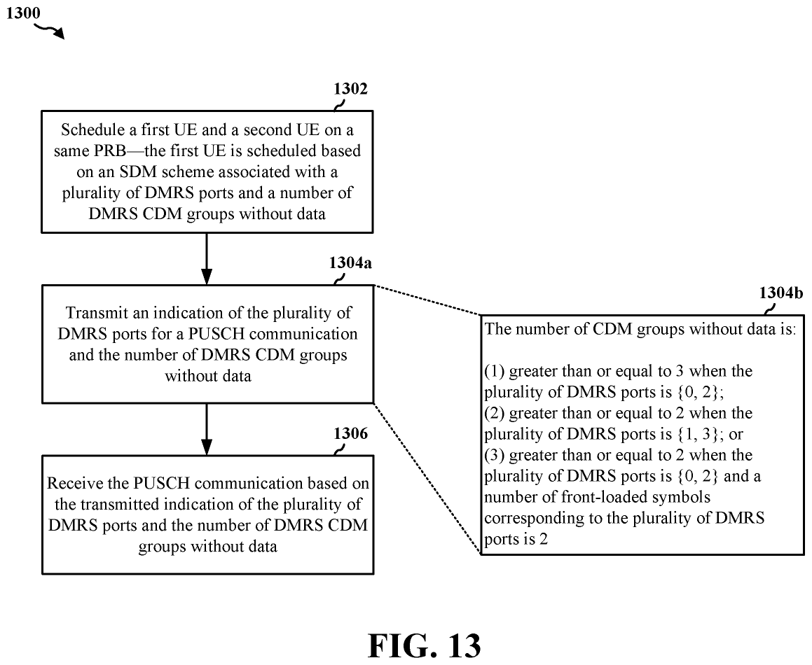

FIG. 13 is a flowchart 1300 of a method of wireless communication. The method may be performed by a base station (e.g., the base station 102, 404; TRP1 804a; TRP2 804b; the apparatus 1502; etc.), which may include the memory 376 and which may be the entire base station 102, 404 or a component of the base station 102, 404, such as the TX processor 316, the RX processor 370, and/or the controller/processor 375.

At 1302, the base station may schedule a first UE and a second UE on a same PRB—the first UE is scheduled based on an SDM scheme associated with a plurality of DMRS ports and a number of DMRS CDM groups without data. For example, referring to FIG. 4, the base station 404 may schedule, at 406a-406b, an MU-MIMO communication based on an SDM scheme for at least one UE. That is, the base station 404 may schedule, at 406a-406b, the first UE 402 and/or the second UE 403 based on the SDM scheme, which may correspond to the indication, at 408a, of the DMRS ports for PUSCH transmission and the number of CDM groups without data.

At 1304a, the base station may transmit an indication of the plurality of DMRS ports for a PUSCH communication and the number of DMRS CDM groups without data. For example, referring to FIG. 4, the base station 404 may transmit, at 408a-408b, an indication to the first UE 402 and/or the second UE 403 of the DMRS ports for the PUSCH transmission and the number of CDM groups without data. The indicated number of CDM ports without data may be associated with an SDM scheme.

At 1304b, the number of CDM groups without data is: (1) greater than or equal to 3 when the plurality of DMRS ports is {0, 2}; (2) greater than or equal to 2 when the plurality of DMRS ports is {1, 3}; or (3) greater than or equal to 2 when the plurality of DMRS ports is {0, 2} and a number of front-loaded symbols corresponding to the plurality of DMRS ports is 2. For example, referring to FIGS. 4-9, the number of CDM groups without data indicated, at 408a-408b, may correspond to configurations indicated, at 408c, where the number of CDM groups without data is: (1)≥ to 3 when DMRS ports {0, 2} is indicated; (2)> to 2 when DMRS ports {1, 3} is indicated; or (3)≥2 when DMRS ports {0, 2} indicated and a number of front-loaded symbols=2. The configurations indicated, at 408c, may correspond to one or more entries of the rank tables 910-930.

At 1306, the base station may receive the PUSCH communication based on the transmitted indication of the plurality of DMRS ports and the number of DMRS CDM groups without data. For example, referring to FIGS. 4 and 9, the base station 404 may receive, at 414a-414b, one or more PUSCHs based on the SDM scheme associated with the transmitted indication, at 408a-408b, of the DMRS ports for the PUSCH transmission and the number of CDM groups without data. The SDM scheme may correspond to one or more entries of the rank tables 910-930.

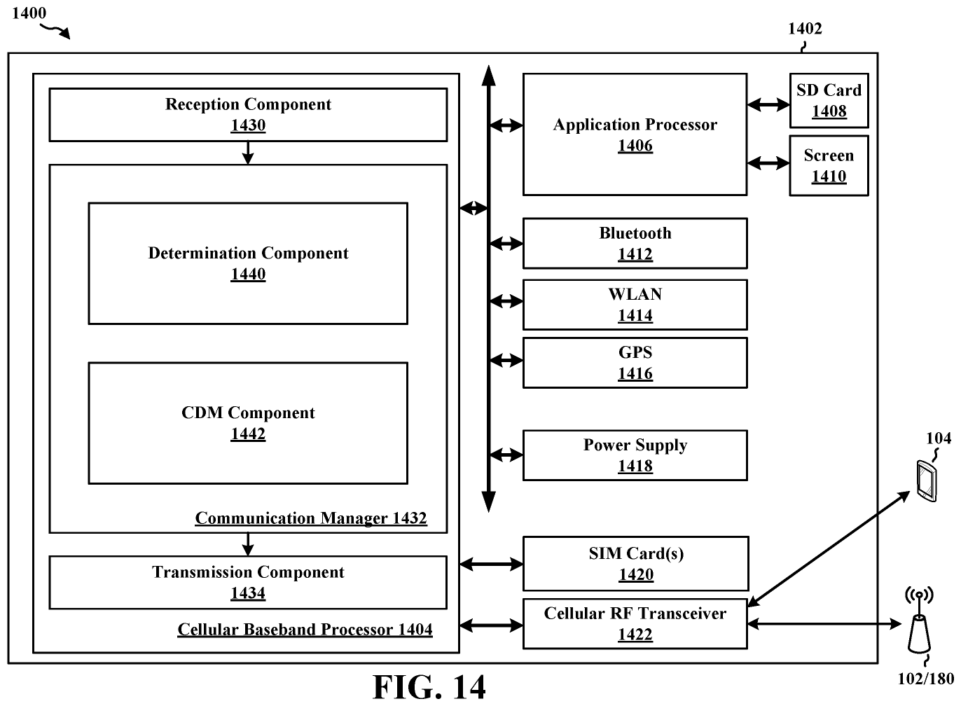

FIG. 14 is a diagram 1400 illustrating an example of a hardware implementation for an apparatus 1402. The apparatus 1402 may be a UE, a component of a UE, or may implement UE functionality. In some aspects, the apparatus 1402 may include a cellular baseband processor 1404 (also referred to as a modem) coupled to a cellular RF transceiver 1422. In some aspects, the apparatus 1402 may further include one or more subscriber identity modules (SIM) cards 1420, an application processor 1406 coupled to a secure digital (SD) card 1408 and a screen 1410, a Bluetooth module 1412, a wireless local area network (WLAN) module 1414, a Global Positioning System (GPS) module 1416, or a power supply 1418. The cellular baseband processor 1404 communicates through the cellular RF transceiver 1422 with the UE 104 and/or BS 102/180. The cellular baseband processor 1404 may include a computer-readable medium/memory. The computer-readable medium/memory may be non-transitory. The cellular baseband processor 1404 is responsible for general processing, including the execution of software stored on the computer-readable medium/memory. The software, when executed by the cellular baseband processor 1404, causes the cellular baseband processor 1404 to perform the various functions described supra. The computer-readable medium/memory may also be used for storing data that is manipulated by the cellular baseband processor 1404 when executing software. The cellular baseband processor 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the cellular baseband processor 1404. The cellular baseband processor 1404 may be a component of the UE 350 and may include the memory 360 and/or at least one of the TX processor 368, the RX processor 356, and the controller/processor 359. In one configuration, the apparatus 1402 may be a modem chip and include just the baseband processor 1404, and in another configuration, the apparatus 1402 may be the entire UE (e.g., see 350 of FIG. 3) and include the additional modules of the apparatus 1402. The reception component 1430 is configured, e.g., as described in connection with 1002 and 1102a, to receive an indication of a plurality of DMRS ports for a PUSCH transmission and a number of DMRS CDM groups without data. The communication manager 1432 includes a determination component 1440 that is configured, e.g., as described in connection with 1104 and 1106, to determine whether an SDM scheme is scheduled; and to determine a table to reference based on the received indication and based on whether the SDM scheme is scheduled—the PUSCH transmission is based on the determined table. The communication manager 1432 further includes a CDM component 1442 that is configured, e.g., as described in connection with 1102b, to indicate that the number of CDM groups without data is: (1) greater than or equal to 3 when the plurality of DMRS ports is {0, 2}; (2) greater than or equal to 2 when the plurality of DMRS ports is {1, 3}; or (3) greater than or equal to 2 when the plurality of DMRS ports is {0, 2} and a number of front-loaded symbols corresponding to the plurality of DMRS ports is 2. The transmission component 1434 is configured, e.g., as described in connection with 1004 and 1108, to transmit the PUSCH transmission based on the received indication of the plurality of DMRS ports and the number of DMRS CDM groups without data.

The apparatus may include additional components that perform each of the blocks of the algorithm in the flowcharts of FIGS. 10-11. As such, each block in the flowcharts of FIGS. 10-11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1402 may include a variety of components configured for various functions. In one configuration, the apparatus 1402, and in particular the cellular baseband processor 1404, includes means for receiving an indication of a plurality of DMRS ports for a PUSCH transmission and a number of DMRS CDM groups without data, wherein the number of DMRS CDM groups without data is: greater than or equal to 3 when the plurality of DMRS ports is {0, 2}, greater than or equal to 2 when the plurality of DMRS ports is {1, 3}, or greater than or equal to 2 when the plurality of DMRS ports is {0, 2} and a number of front-loaded symbols corresponding to the plurality of DMRS ports is 2; and means for transmitting the PUSCH transmission based on the received indication of the plurality of DMRS ports and the number of DMRS CDM groups without data. The apparatus 1402 further includes means for determining whether an SDM scheme is scheduled. The apparatus 1402 further includes means for determining a table to reference based on the received indication and based on whether the SDM scheme is scheduled, wherein the PUSCH transmission is based on the determined table.

The means may be one or more of the components of the apparatus 1402 configured to perform the functions recited by the means. As described supra, the apparatus 1402 may include the TX Processor 368, the RX Processor 356, and the controller/processor 359. As such, in one configuration, the means may be the TX Processor 368, the RX Processor 356, and the controller/processor 359 configured to perform the functions recited by the means.

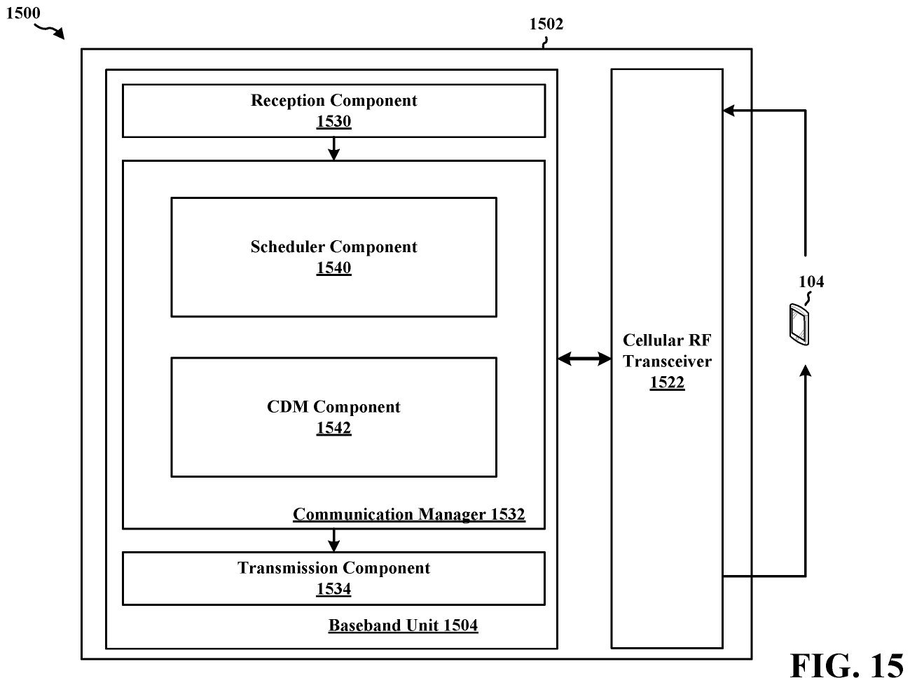

FIG. 15 is a diagram 1500 illustrating an example of a hardware implementation for an apparatus 1502. The apparatus 1502 may be a base station, a component of a base station, or may implement base station functionality. In some aspects, the apparatus 1502 may include a baseband unit 1504. The baseband unit 1504 may communicate through a cellular RF transceiver 1522 with the UE 104. The baseband unit 1504 may include a computer-readable medium/memory. The baseband unit 1504 is responsible for general processing, including the execution of software stored on the computer-readable medium/memory. The software, when executed by the baseband unit 1504, causes the baseband unit 1504 to perform the various functions described supra. The computer-readable medium/memory may also be used for storing data that is manipulated by the baseband unit 1504 when executing software. The baseband unit 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the baseband unit 1504. The baseband unit 1504 may be a component of the base station 310 and may include the memory 376 and/or at least one of the TX processor 316, the RX processor 370, and the controller/processor 375.

The reception component 1530 is configured, e.g., as described in connection with 1204 and 1306, to receive the PUSCH communication based on the transmitted indication of the plurality of DMRS ports and the number of DMRS CDM groups without data. The communication manager 1532 includes a scheduler component 1540 that is configured, e.g., as described in connection with 1302, to schedule a first UE and a second UE on a same PRB—the first UE is scheduled based on an SDM scheme associated with a plurality of DMRS ports and a number of DMRS CDM groups without data. The communication manager 1532 further includes a CDM component 1542 that is configured, e.g., as described in connection with 1304b, to indicate that the number of CDM groups without data is: (1) greater than or equal to 3 when the plurality of DMRS ports is {0, 2}; (2) greater than or equal to 2 when the plurality of DMRS ports is {1, 3}; or (3) greater than or equal to 2 when the plurality of DMRS ports is {0, 2} and a number of front-loaded symbols corresponding to the plurality of DMRS ports is 2. The transmission component 1534 is configured, e.g., as described in connection with 1202 and 1304a, to transmit an indication of the plurality of DMRS ports for a PUSCH communication and the number of DMRS CDM groups without data.

The apparatus may include additional components that perform each of the blocks of the algorithm in the flowcharts of FIGS. 12-13. As such, each block in the flowcharts of FIGS. 12-13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1502 may include a variety of components configured for various functions. In one configuration, the apparatus 1502, and in particular the baseband unit 1504, includes means for transmitting an indication of a plurality of DMRS ports for a PUSCH transmission and a number of DMRS CDM groups without data, wherein the number of DMRS CDM groups without data is: greater than or equal to 3 when the plurality of DMRS ports is {0, 2}, greater than or equal to 2 when the plurality of DMRS ports is {1, 3}, or greater than or equal to 2 when the plurality of DMRS ports is {0, 2} and a number of front-loaded symbols corresponding to the plurality of DMRS ports is 2; and means for receiving the PUSCH transmission based on the transmitted indication of the plurality of DMRS ports and the number of DMRS CDM groups without data.

The means may be one or more of the components of the apparatus 1502 configured to perform the functions recited by the means. As described supra, the apparatus 1502 may include the TX Processor 316, the RX Processor 370, and the controller/processor 375. As such, in one configuration, the means may be the TX Processor 316, the RX Processor 370, and the controller/processor 375 configured to perform the functions recited by the means. The apparatus 1502 further includes means for scheduling a first UE and a second UE on a same PRB, the first UE scheduled based on an SDM scheme associated with the plurality of DMRS ports and the number of DMRS CDM groups without data.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE including at least one processor coupled to a memory and configured to: receive an indication of a plurality of DMRS ports for a PUSCH transmission and a number of DMRS CDM groups without data, wherein the number of DMRS CDM groups without data is: greater than or equal to 3 when the plurality of DMRS ports is {0, 2}, greater than or equal to 2 when the plurality of DMRS ports is {1, 3}, or greater than or equal to 2 when the plurality of DMRS ports is {0, 2} and a number of front-loaded symbols corresponding to the plurality of DMRS ports is 2; and transmit the PUSCH transmission based on the received indication of the plurality of DMRS ports and the number of DMRS CDM groups without data.

Aspect 2 may be combined with aspect 1 and includes that the plurality of DMRS ports includes a first DMRS port associated with a first DMRS CDM group and a second DMRS port associated with a second DMRS CDM group, the received indication indicates the first DMRS port associated with the first DMRS CDM group and the second DMRS port associated with the second DMRS CDM group.

Aspect 3 may be combined with any of aspects 1-2 and includes that the first DMRS port is of a first plurality of DMRS ports associated with the first DMRS CDM group and the second DMRS port is of a second plurality of DMRS ports associated with the second DMRS CDM group.

Aspect 4 may be combined with any of aspects 1-3 and includes that the first plurality of DMRS ports includes DMRS ports {0,1}, the second plurality of DMRS ports includes DMRS ports {2,3}, the first DMRS port is DMRS port 0, the second DMRS port is DMRS port 2, and the received indication indicates DMRS ports {0,2} with at least 3 DMRS CDM groups without data.

Aspect 5 may be combined with any of aspects 1-3 and includes that the first plurality of DMRS ports includes DMRS ports {0,1}, the second plurality of DMRS ports includes DMRS ports {2,3}, the first DMRS port is DMRS port 1, the second DMRS port is DMRS port 3, and the received indication indicates DMRS ports {1,3} with at least 2 DMRS CDM groups without data.

Aspect 6 may be combined with any of aspects 1-3 or 5 and includes that the first plurality of DMRS ports includes DMRS ports {0,1}, the second plurality of DMRS ports includes DMRS ports {2,3}, the first DMRS port is DMRS port 1, the second DMRS port is DMRS port 3, the first DMRS port and the second DMRS port corresponding to at least one front-loaded DMRS symbol.

Aspect 7 may be combined with any of aspects 1-6 and includes that the first DMRS port associated with the first DMRS CDM group and the second DMRS port associated with the second DMRS CDM group correspond to two front-loaded DMRS symbols.

Aspect 8 may be combined with any of aspects 1-7 and includes that the first DMRS port associated with the first DMRS CDM group is included in a first set of one or more DMRS ports, the second DMRS port associated with the second DMRS CDM group is included in a second set of one or more DMRS ports, the received indication indicates the first set of one or more DMRS ports and the second set of one or more DMRS ports, at least one of the first set of one or more DMRS ports or the second set of one or more DMRS ports corresponding to two front-loaded DMRS symbols.

Aspect 9 may be combined with any of aspects 1-8 and includes that the at least one processor is further configured to: determine whether an SDM scheme is scheduled; and determine a table to reference based on the received indication and based on whether the SDM scheme is scheduled, wherein the PUSCH transmission is based on the determined table.

Aspect 10 may be combined with any of aspects 1-9 and includes that the received indication of the plurality of DMRS ports and the number of DMRS CDM groups without data is indicated based on at least one of DCI or RRC signaling.

Aspect 11 may be combined with any of aspects 1-10 and includes that the plurality of DMRS ports is associated with SDM based on different sets of one or more layers that correspond to different transmission parameters.

Aspect 12 is an apparatus for wireless communication at a base station including at least one processor coupled to a memory and configured to: transmit an indication of a plurality of DMRS ports for a PUSCH transmission and a number of DMRS CDM groups without data, wherein the number of DMRS CDM groups without data is: greater than or equal to 3 when the plurality of DMRS ports is {0, 2}, greater than or equal to 2 when the plurality of DMRS ports is {1, 3}, or greater than or equal to 2 when the plurality of DMRS ports is {0, 2} and a number of front-loaded symbols corresponding to the plurality of DMRS ports is 2; and receive the PUSCH transmission based on the transmitted indication of the plurality of DMRS ports and the number of DMRS CDM groups without data.

Aspect 13 may be combined with aspect 12 and includes that the plurality of DMRS ports includes a first DMRS port associated with a first DMRS CDM group and a second DMRS port associated with a second DMRS CDM group, the transmitted indication indicates the first DMRS port associated with the first DMRS CDM group and the second DMRS port associated with the second DMRS CDM group.

Aspect 14 may be combined with any of aspects 12-13 and includes that the first DMRS port is of a first plurality of DMRS ports associated with the first DMRS CDM group and the second DMRS port is of a second plurality of DMRS ports associated with the second DMRS CDM group.

Aspect 15 may be combined with any of aspects 12-14 and includes that the first plurality of DMRS ports includes DMRS ports {0,1}, the second plurality of DMRS ports includes DMRS ports {2,3}, the first DMRS port is DMRS port 0, the second DMRS port is DMRS port 2, and the transmitted indication indicates DMRS ports {0,2} with at least 3 DMRS CDM groups without data.

Aspect 16 may be combined with any of aspects 12-14 and includes that the first plurality of DMRS ports includes DMRS ports {0,1}, the second plurality of DMRS ports includes DMRS ports {2,3}, the first DMRS port is DMRS port 1, the second DMRS port is DMRS port 3, and the transmitted indication indicates DMRS ports {1,3} with at least 2 DMRS CDM groups without data.

Aspect 17 may be combined with any of aspects 12-14 or 16 and includes that the first plurality of DMRS ports includes DMRS ports {0,1}, the second plurality of DMRS ports includes DMRS ports {2,3}, the first DMRS port is DMRS port 1, the second DMRS port is DMRS port 3, the first DMRS port and the second DMRS port corresponding to at least one front-loaded DMRS symbol.

Aspect 18 may be combined with any of aspects 12-17 and includes that the first DMRS port associated with the first DMRS CDM group and the second DMRS port associated with the second DMRS CDM group correspond to two front-loaded DMRS symbols.

Aspect 19 may be combined with any of aspects 12-18 and includes that the first DMRS port associated with the first DMRS CDM group is included in a first set of one or more DMRS ports, the second DMRS port associated with the second DMRS CDM group is included in a second set of one or more DMRS ports, the transmitted indication indicates the first set of one or more DMRS ports and the second set of one or more DMRS ports, at least one of the first set of one or more DMRS ports or the second set of one or more DMRS ports corresponding to two front-loaded DMRS symbols.

Aspect 20 may be combined with any of aspects 12-19 and includes that the transmitted indication indicates a table to reference based on whether an SDM scheme is scheduled, the PUSCH transmission based on the table.

Aspect 21 may be combined with any of aspects 12-20 and includes that the transmitted indication of the plurality of DMRS ports and the number of DMRS CDM groups without data is indicated based on at least one of DCI or RRC signaling.

Aspect 22 may be combined with any of aspects 12-21 and includes that the plurality of DMRS ports is associated with SDM based on different sets of one or more layers that correspond to different transmission parameters.

Aspect 23 may be combined with any of aspects 12-22 and includes that the at least one processor is further configured to schedule a first UE and a second UE on a same PRB, the first UE scheduled based on an SDM scheme associated with the plurality of DMRS ports and the number of DMRS CDM groups without data.

Aspect 24 may be combined with any of aspects 12-23 and includes that the scheduling of the first UE is based on at least one of a rank combination for the SDM scheme, an MU-MIMO communication, a number of co-scheduled UEs, a rank of the co-scheduled UEs, a DMRS configuration type, or a maximum length of DMRS symbols.

Aspect 25 may be combined with any of aspects 1-24 and further includes at least one of an antenna or a transceiver coupled to the at least one processor.

Aspect 26 is a method of wireless communication for implementing any of aspects 1-25.

Aspect 27 is an apparatus for wireless communication including means for implementing any of aspects 1-25.

Aspect 28 is a computer-readable medium storing computer executable code, the code when executed by at least one processor causes the at least one processor to implement any of aspects 1-25.

1. An apparatus for wireless communication at a user equipment (UE), comprising:
a memory; and
at least one processor coupled to the memory and configured to:
receive an indication of a plurality of demodulation reference signal (DMRS) ports for a physical uplink shared channel (PUSCH) transmission and a number of DMRS code division multiplexing (CDM) groups without data,
wherein the number of DMRS CDM groups without data is:
greater than or equal to 2 when the plurality of DMRS ports is {1, 3}; and
transmit the PUSCH transmission based on the received indication of the plurality of DMRS ports and the number of DMRS CDM groups without data.

2. The apparatus of claim 1, wherein the plurality of DMRS ports includes a first DMRS port associated with a first DMRS CDM group and a second DMRS port associated with a second DMRS CDM group, the received indication indicates the first DMRS port associated with the first DMRS CDM group and the second DMRS port associated with the second DMRS CDM group.

3. The apparatus of claim 2, wherein the first DMRS port is of a first plurality of DMRS ports associated with the first DMRS CDM group and the second DMRS port is of a second plurality of DMRS ports associated with the second DMRS CDM group.

4. The apparatus of claim 3, wherein the first plurality of DMRS ports includes DMRS ports {0,1}, the second plurality of DMRS ports includes DMRS ports {2,3}, the first DMRS port is DMRS port 0, the second DMRS port is DMRS port 2, and the received indication indicates DMRS ports {0,2} with at least 3 DMRS CDM groups without data.

5. The apparatus of claim 3, wherein the first plurality of DMRS ports includes DMRS ports {0,1}, the second plurality of DMRS ports includes DMRS ports {2,3}, the first DMRS port is DMRS port 1, the second DMRS port is DMRS port 3, and the received indication indicates DMRS ports {1,3} with at least 2 DMRS CDM groups without data.

6. The apparatus of claim 3, wherein the first plurality of DMRS ports includes DMRS ports {0,1}, the second plurality of DMRS ports includes DMRS ports {2,3}, the first DMRS port is DMRS port 1, the second DMRS port is DMRS port 3, the first DMRS port and the second DMRS port corresponding to at least one front-loaded DMRS symbol.

7. The apparatus of claim 2, wherein the first DMRS port associated with the first DMRS CDM group and the second DMRS port associated with the second DMRS CDM group correspond to two front-loaded DMRS symbols.

8. The apparatus of claim 7, wherein the first DMRS port associated with the first DMRS CDM group is included in a first set of one or more DMRS ports, the second DMRS port associated with the second DMRS CDM group is included in a second set of one or more DMRS ports, the received indication indicates the first set of one or more DMRS ports and the second set of one or more DMRS ports, at least one of the first set of one or more DMRS ports or the second set of one or more DMRS ports corresponding to two front-loaded DMRS symbols.

9. (canceled)

10. The apparatus of claim 1, wherein the received indication of the plurality of DMRS ports and the number of DMRS CDM groups without data is indicated based on at least one of downlink control information (DCI) or radio resource control (RRC) signaling.

11. The apparatus of claim 1, wherein the plurality of DMRS ports is associated with spatial division multiplexing (SDM) based on different sets of one or more layers that correspond to different transmission parameters.

12. An apparatus for wireless communication at a base station, comprising:
a memory; and
at least one processor coupled to the memory and configured to:
transmit an indication of a plurality of demodulation reference signal (DMRS) ports for a physical uplink shared channel (PUSCH) transmission and a number of DMRS code division multiplexing (CDM) groups without data,
wherein the number of DMRS CDM groups without data is:
greater than or equal to 2 when the plurality of DMRS ports is {1, 3}; and
receive the PUSCH transmission based on the transmitted indication of the plurality of DMRS ports and the number of DMRS CDM groups without data.

13. The apparatus of claim 12, wherein the plurality of DMRS ports includes a first DMRS port associated with a first DMRS CDM group and a second DMRS port associated with a second DMRS CDM group, the transmitted indication indicates the first DMRS port associated with the first DMRS CDM group and the second DMRS port associated with the second DMRS CDM group.

14. The apparatus of claim 13, wherein the first DMRS port is of a first plurality of DMRS ports associated with the first DMRS CDM group and the second DMRS port is of a second plurality of DMRS ports associated with the second DMRS CDM group.

15. The apparatus of claim 14, wherein the first plurality of DMRS ports includes DMRS ports {0,1}, the second plurality of DMRS ports includes DMRS ports {2,3}, the first DMRS port is DMRS port 0, the second DMRS port is DMRS port 2, and the transmitted indication indicates DMRS ports {0,2} with at least 3 DMRS CDM groups without data.

16. The apparatus of claim 14, wherein the first plurality of DMRS ports includes DMRS ports {0,1}, the second plurality of DMRS ports includes DMRS ports {2,3}, the first DMRS port is DMRS port 1, the second DMRS port is DMRS port 3, and the transmitted indication indicates DMRS ports {1,3} with at least 2 DMRS CDM groups without data.

17. The apparatus of claim 14, wherein the first plurality of DMRS ports includes DMRS ports {0,1}, the second plurality of DMRS ports includes DMRS ports {2,3}, the first DMRS port is DMRS port 1, the second DMRS port is DMRS port 3, the first DMRS port and the second DMRS port corresponding to at least one front-loaded DMRS symbol.

18. The apparatus of claim 13, wherein the first DMRS port associated with the first DMRS CDM group and the second DMRS port associated with the second DMRS CDM group correspond to two front-loaded DMRS symbols.

19. The apparatus of claim 18, wherein the first DMRS port associated with the first DMRS CDM group is included in a first set of one or more DMRS ports, the second DMRS port associated with the second DMRS CDM group is included in a second set of one or more DMRS ports, the transmitted indication indicates the first set of one or more DMRS ports and the second set of one or more DMRS ports, at least one of the first set of one or more DMRS ports or the second set of one or more DMRS ports corresponding to two front-loaded DMRS symbols.

20. The apparatus of claim 12, wherein the transmitted indication indicates a table to reference based on whether a spatial division multiplexing (SDM) scheme is scheduled, the PUSCH transmission based on the table.

21-36. (canceled)

37. An apparatus for wireless communication at a user equipment (UE), comprising:
a memory; and
at least one processor coupled to the memory and configured to:
receive an indication of a plurality of demodulation reference signal (DMRS) ports for a physical uplink shared channel (PUSCH) transmission and a number of DMRS code division multiplexing (CDM) groups without data, wherein the number of DMRS CDM groups without data is greater than or equal to 2 when the plurality of DMRS ports is {1, 3};
determine whether a spatial division multiplexing (SDM) scheme is scheduled;
determine a table to reference based on the received indication and based on whether the SDM scheme is scheduled; and
transmit the PUSCH transmission based on the received indication of the plurality of DMRS ports and the number of DMRS CDM groups without data, wherein the PUSCH transmission is based on the determined table.
